(19) United States
(12) Patent Application Publication
(10) Pub. No.: US 2014/0099445 A1
(43) Pub. Date: Apr. 10, 2014

(54) METHOD FOR PRODUCING A FILM HAVING A NANO-STRUCTURE ON THE SURFACE OF THE FILM

(71) Applicants: SUMITOMO CHEMICAL COMPANY, LIMITED, Tokyo (JP); UNIVERSITY OF MASSACHUSETTS, Amherst, MA (US)

(72) Inventors: Ryu TAKEKO, Amherst, MA (US); Thomas P. RUSSELL, Amherst, MA (US)

(73) Assignees: UNIVERSITY OF MASSACHUSETTS, Amherst, MA (US); SUMITOMO CHEMICAL COMPANY, LIMITED, Tokyo (JP)

(21) Appl. No.: 13/647,727

(22) Filed: Oct. 9, 2012

(51) Int. Cl. B05D 5/00

(52) U.S. Cl. CPC B05D 5/00; B82Y 30/00
USPC 427/385.5; 977/700

(57) ABSTRACT

A method is provided for producing easily a membrane (film) having a micro surface structure (porous structure, fibrous structure and the like) in nano-order. The method for producing a film having a nano-structure on the surface of the film, includes the steps of: (1) coating a substrate with a solution containing a copolymer including two or more homopolymer segments and an organic solvent having boiling point of 82° C. or more and a dielectric constant of 30 or less to form a membrane; (2) providing the membrane with a water vapor-containing gas having a relative humidity of 50% or more to age the membrane; and (3) drying the membrane to obtain the film.

### BACKGROUND OF THE INVENTION

The present invention relates to a method for producing a film having a nano-structure on the surface of the film, specifically, a method for producing a film having a nano-structure on the surface of the film obtained by using a polymer and a solvent under the presence of a water vapor-containing gas.

A polymer film has been produced by using a casting method for a long time. In recent years, different films have been produced by applying this method. It is desired that a film having a nano-structure is applied to, for example, a solar battery, a separation membrane, antireflective film and the like. Therefore, in the case where the film having a nano-structure is produced, the casting method also has been suitably modified and utilized.

For example, Patent Reference 1 (Japanese unexamined patent application publication No. 2011-105780) discloses a method for forming a porous film which contains the steps of coating a substrate with a solution of an organic compound and a hydrophobic organic solvent, evaporating the hydrophobic organic solvent to cool the coating layer, and condensing moisture on the coating layer by supplying a steam having higher dew point than the temperature of the coating layer (hereinafter referred to as “Breath Figure method”). Patent Reference 2 (Japanese unexamined patent application publication No. 2006-70254) also discloses the same method. In addition, technologies for producing a film having a unique structure by utilizing the asymmetric nature of block polymers also have been known. For example, Patent Reference 3 (Japanese unexamined patent application publication No. 2010-504189) discloses a method for producing an asymmetric membrane which contains the steps of coating a substrate with a mixture of a block polymer and a solvent, and immersing the substrate into a poor solvent (for example, water) to precipitate the block polymer. Non Patent Reference 1 (Polym. Adv. Technol., 2011, vol. 22, pp 2145-2150) discloses that an amphiphilic block polymer can be self-assembled by coating glass with a DMF solution of the block polymer and drying the coated glass in steam.

### SUMMARY OF THE INVENTION

However, in the Breath Figure method disclosed in Patent References 1 and 2, the method requires that a coating layer is cooled by absorbing latent heat during evaporation of an organic solvent, and moisture is condensed into water on the cooled coating layer. As a result, steam is drastically cooled in some cases, and the condensed water droplets, which serve to form concave or spherical concave in the coating layer, easily become large. Therefore, the obtained porous membrane has a pore size in micron scale in some cases. In addition, when the layer is thin, some layers cannot become porous. In the Breath Figure method, sufficient absorbance of evaporative latent heat is needed to cool the layer. When the layer is thin, the layer is soon dried and the absorbance of latent heat and cooling of the layer become insufficient. Further, there is a problem that working environment gets worse when an organic solvent of low boiling point is used to effectively generate evaporative latent heat.

On the other hand, an immersing technology disclosed in Patent Reference 3 requires a pool for immersing a membrane and storing a poor solvent. In addition, the surface of the coating layer easily becomes turbulent when a substrate is rolled at higher speed due to great drag of the poor solvent in the pool. Compositions of a solution of the pool tend to change sequentially, so it is difficult to maintain the composition of the solution constantly. Therefore, in the case of Patent Reference 3, it is difficult to improve the productivity of membranes. Further, in Non Patent Reference 1 in which a block polymer in DMF (dielectric constant 38) is self-assembled, there is a problem that an obtained structure is granular and a structure becomes coarse in higher moisture.

The problem to be solved by the present invention is to provide a method for producing easily a membrane (film) having a micro surface structure (porous structure, fibrous structure and the like) in nano-order. According to the method, for example, it is easy to produce a membrane (film) by roll to roll process.

The present inventors have conducted intensive research in order to solve the problem. As a result, the inventors found that films having fine structures on the surface can be formed by dissolving a copolymer having two or more homopolymer segments such as a block polymer or a graft polymer into a specific organic solvent to form a mixture, exposing the mixture in atmosphere of higher moisture, and self-assembling the copolymer in nano-order relative to gas, regardless of a convenient process without requiring special methods, and preferably found that films having good structures such as a porous structure or a fibrous structure on the surface can be formed. Consequently, the present invention has been accomplished.

Specifically, the method for producing a film having a nano-structure on the surface of the film according to the present invention contains the following embodiments.

[1] A method for producing a film having a nano-structure on the surface of the film, comprising the steps of

(1) coating a substrate with a solution containing a copolymer including two or more homopolymer segments and an organic solvent having boiling point of 82° C. or more and dielectric constant of 30 or less to form a membrane,

(2) providing the membrane with a water vapor-containing gas having relative humidity of 50% or more to age the membrane, and

(3) drying the membrane to obtain the film.

[2] The method according to [1], wherein the copolymer is an amphiphilic polymer containing a hydrophilic homopolymer segment and a hydrophobic homopolymer segment.
[3] The method according to [1], wherein the homopolymer segments are an organic polymer segment containing a carbon atom in the main chain or an inorganic polymer segment containing no carbon atom in the main chain.
[4] The method according to [2], wherein the hydrophobic homopolymer segment is an inorganic polymer segment or an organic polymer segment obtained from a hydrophobic monomer having water solubility of 1% by mass or less, and the hydrophilic homopolymer segment is an organic polymer segment obtained from a hydrophilic monomer having water solubility of more than 1% by mass.
[5] The method according to [4], wherein the hydrophobic monomer is constituted from a carbon atom, a hydrogen atom and a halogen atom as needed, and the hydrophilic monomer is constituted from a carbon atom, a hydrogen atom and a functional group other than a halogen atom.
[6] The method according to [2], wherein the volume of the hydrophilic homopolymer segment is 10% or more relative to the total volume of the hydrophilic homopolymer segment and the hydrophobic homopolymer segment.
[7] The method according to [1], wherein the temperature of the surface of the membrane in the step (2) is 15° C. or more.
[8] The method according to [1], wherein the organic solvent is a non-halogen solvent.
[9] The method according to [1], wherein the organic solvent is a hydrophobic solvent.
[10] The method according to [1], wherein the organic solvent is a hydrophilic solvent.
[11] The method according to [1], wherein the organic solvent is a solvent mixture containing two or more solvents.
[12] The method according to [1], wherein the organic solvent is a solvent mixture containing a hydrophobic solvent and a hydrophilic solvent.
[13] The method according to [12], further comprising an additive agent having an affinity for the hydrophilic homopolymer segment.

According to the present invention, a film having an appropriate nano-structure can be produced by using a solution containing a copolymer including a hydrophilic homopolymer segment and an organic solvent having boiling point of 82° C. or more and dielectric constant of 30 or less, and controlling relative humidity. In addition, the film having a nano-structure on the surface of the film can be produced by interacting the hydrophilic homopolymer segment of a copolymer and water vapor contained in gas, and appropriately orienting the copolymer in the membrane. Further, the film having a nano-structure on the surface of the film can be conveniently produced in roll to roll process by giving just only a combination of a copolymer and an organic solvent as well as relative humidity.

### BRIEF DESCRIPTION OF THE DRAWINGS

FIG. 1 is a SEM photograph for a film having a nano-structure on the surface of the film obtained in Example 1.

FIG. 2 is a SEM photograph for a film having a nano-structure on the surface of the film obtained in Example 2.

FIG. 3 is a SEM photograph for a film having a nano-structure on the surface of the film obtained in Example 3.

FIG. 4 is a SEM photograph from the top view of a film having a nano-structure on the surface of the film obtained in Example 4.

FIG. 5 is a SEM photograph from the cross-section view of a film having a nano-structure on the surface of the film obtained in Example 4.

FIG. 6 is a SEM photograph for a film having a nano-structure on the surface of the film obtained in Example 5.

FIG. 7 is a SEM photograph for a film obtained in Comparative Example 1.

FIG. 8 is a SEM photograph for a film obtained in Comparative Example 2.

FIG. 9 is a SEM photograph for a film obtained in Comparative Example 3.

### DESCRIPTION OF THE PREFERRED EMBODIMENTS

The present invention comprises a method for producing a film having a nano-structure on the surface of the film, which contains the steps of coating a substrate with a solution containing a copolymer including two or more homopolymer segments (hereinafter each segment or all segments of the “two or more homopolymer segments” are simply referred to as “segment(s)” in some cases) and an organic solvent having boiling point of 82° C. or more and dielectric constant of 30 or less to form a membrane (referred to as step (1)), providing the membrane with a water vapor-containing gas having relative humidity of 50% or more to age the membrane (referred to as step (2)), and drying the membrane to obtain the film (referred to as step (3)). According to the method of the present invention, a film having a nano-structure on the surface of the film can be produced. In addition, self-assembly of the copolymer can be simply controlled in nano-order by coating a substrate with a solution of the copolymer and the organic solvent, and providing the substrate with a water vapor-containing gas of relative humidity of 50% or more. Therefore, a film having a nano-structure on the surface of the film can be easily produced in a roll to roll process. Each step of the method of the present invention is described in detail as follows.

### 1. Step (1): Coating Step (1)

In coating step, it is important that the specific copolymer and the specific organic solvent are used. In the case where the specific copolymer and the specific organic solvent are used, the copolymer can be assembled in the next aging step.

### 1.1 Copolymer

The copolymer is constituted from two or more segments as above-mentioned. Each copolymer having multiple segments has different physical properties in a molecular due to asymmetric structures, and the different physical properties from the asymmetric structures advantageously affect self-assembly of the copolymer. The copolymer having the asymmetric structures includes, for example, a block polymer and a graft polymer. In the block polymer, the homopolymer segment is generally referred to as a block. In the graft polymer, the homopolymer segment is generally referred to as a backbone polymer, a branched polymer and the like. In the case where the homopolymer segment is shown in alphabets such as A, B and C, the block polymer can include a block polymer having two blocks such as A-B, A-B-A and B-A-B, and a block polymer having three or more blocks such as A-B-C, A-C-B, B-A-C, A-B-C-A and A-B-C-B. The graft polymer can include a graft polymer having two kinds of polymers such that multiple branched polymers B are bonded to a backbone polymer A, a graft polymer having three or more kinds of polymers such that different branched polymers B and C are bonded to a backbone polymer A and the like. Preferable copolymer is the block polymer, especially the block polymer having two blocks. The copolymer is easily self-assembled. The only one copolymer may be used, or the mixture of the two or more copolymers may be used.

The combination of two or more homopolymer segments for constituting the copolymer is not particularly limited, as long as these segments are different in each other. The difference of the segments contributes to self-assembly of the copolymer. Preferable copolymer is the one such that at least one of two or more homopolymer segments is a hydrophilic homopolymer segment (hereinafter simply referred to as “hydrophilic segment” in some cases) and at least one of two or more homopolymer segments is a hydrophobic homopolymer segment (hereinafter simply referred to as “hydrophobic segment” in some cases). When the copolymer is constituted from the hydrophilic segment and the hydrophobic segment, the clear differences of the physical properties between these segments promote self-assembly. In specification of the present application, the copolymer having the hydrophilic segment and the hydrophobic segment is referred to as an amphiphilic polymer.

The homopolymer segment is classified into an organic polymer segment containing a carbon atom in the main chain or an inorganic polymer segment containing no carbon atom in the main chain. The classification of each segment into either the hydrophobic segment or the hydrophilic segment is determined according to classification of each segment into either an organic segment or an inorganic segment. In the case where the homopolymer segment is the organic segment, a polymer produced from a hydrophobic monomer can be used as the hydrophobic segment. The hydrophobic monomer is a monomer which has water solubility of 1% by mass or less at room temperature (25° C.). The hydrophobic monomer is constituted from, for example, a carbon atom, a hydrogen atom and optionally a halogen atom (for example, a chlorine atom, a fluorine atom, or a bromide atom). Therefore, the hydrophobic segment is most preferably a polymer produced from a hydrocarbon monomer or a halogenated hydrocarbon monomer. Here, this merely represents a monomer capable of be likely the hydrophobic monomer. In the case where water solubility is over 1% by mass, the monomer is classified into a hydrophilic monomer as described later even if the monomer falls into the above requirement.

The polymer produced from a hydrocarbon monomer includes, for example, an aliphatic hydrocarbon polymer such as polyethylene (PE), polypropylene (PP), polybutadiene (PB), polyisoprene, a hydrocarbon polymer having an aromatic ring such as polystyrene (PS). The polymer produced from a halogenated hydrocarbon monomer includes polyvinyl chloride, polyvinylidene chloride, polyvinyl fluoride and the like.

In the case where the homopolymer segment is the organic segment, the polymer produced from a hydrophilic monomer can be used as the hydrophilic segment. The hydrophilic monomer is a monomer which has water solubility of above 1% by mass at room temperature (25° C.). The hydrophilic monomer is a segment having a carbon atom, a hydrogen atom, a group (a functional group) containing an atom other than an atom (a carbon atom, a hydrogen atom, or a halogen atom) used in the hydrophobic segment. The hydrophilic monomer may contain another atom (for example, a halogen atom or the like). The functional group improves hydrophilicity of the hydrophilic monomer. The functional group includes an oxygen atom-containing group such as a carboxyl group (from example, an ester group, a carboxylic acid group), an ether group, and a hydroxyl group; a nitrogen atom-containing group such as an amino group and a pyridinyl group; oxygen and nitrogen atoms-containing group such as an amide group; an onium group, a sulfonium group and the like. The functional group is preferably an oxygen atom-containing group, and particularly preferably an ether group. The functional group may be introduced in the main chain or the side chain of the segment polymer. Here, this merely represents a monomer capable of be likely the hydrophilic monomer. When water solubility is 1% by mass or less, the monomer is classified into the hydrophobic monomer even if the monomer falls into the above requirement.

The hydrophilic segment (the polymer produced from a hydrophilic monomer) contains, for example, an oxygen atom-containing group, a nitrogen atom-containing group, and/or oxygen and nitrogen atoms-containing group. The hydrophilic segment is preferably selected from the group consisting of polylactide, polyalkyl(meth)acrylate, poly(meth)acrylate, polyalkylene oxide, polycaprolacton, polyvinyl alcohol, polyvinyl pyridine, polyacrylamide and polyvinyl pyrrolidone. Among these, the hydrophilic segment is more preferably polyalkylene oxide, particularly preferably polyethylene oxide (PEO) and polypropylene oxide, and most preferably polyethylene oxide. Incidentally, polylactide, polyalkyl(meth)acrylate, poly(meth)acrylate and the like may fall into the hydrophobic segment (the polymer produced from a hydrophobic monomer) according to compositions of polymers.

On the other hand, the inorganic segment is classified into a hydrophobic segment. A main chain (a repeated unit) constituting the inorganic segment contains, for example, a repeated unit (a siloxane unit) consisting of a silicon atom and an oxygen atom. An appropriate group, for example, a hydrocarbon group such as an alkyl group, an aryl group, and an aralkyl group may be bound to the main chain. The inorganic segment is preferably alkylpolysiloxane (e.g. polydimethylsiloxane), unsubstituted polysiloxane and the like.

The combination of the hydrophobic segment and the hydrophilic segment is not particularly limited, as long as the hydrophobic segment is constituted from a carbon atom and a hydrogen atom and the hydrophilic segment is constituted from a carbon atom, a hydrogen atom and a functional group. It is possible to self-assemble the amphiphilic polymer in any combinations. In a preferable combination, the hydrophobic segment is a hydrocarbon polymer having an aromatic ring, particularly polystyrene and the hydrophilic segment is a polymer having an oxygen atom-containing group in the main chain, particularly polyalkylene oxide. Most preferable amphiphilic polymer is a block polymer having two kinds of homopolymer segments in the above preferable combination of the hydrophobic segment and the hydrophilic segment, specifically polystyrene-b-polyalkylene oxide (particularly polystyrene-b-polyethylene oxide).

When the ratio of the hydrophobic segment and the hydrophilic segment is controlled, the degree of self-assembly can also be controlled. The ratio can be controlled as the ratio of the volume of the hydrophobic segment to the volume of the hydrophilic segment. The volume of the hydrophilic segment is preferably 10% or more, more preferably 15% or more, even preferably 20% or more, and even more preferably 25% or more, preferably 90% or less, more preferably 85% or less, even preferably 80% or less, and even more preferably 75% or less, relative to the total volume of the hydrophilic segment and the hydrophobic segment. The ratio of each volume (volume of hydrophobic segment/volume of hydrophilic segment) may be identical with the ratio of each value, wherein each value is (X) a value in the case where the number average molecular weight of the hydrophobic segment is divided by the density of the hydrophobic segment or (Y) a value in the case where the number average molecular weight of the hydrophilic segment is divided by the density of the hydrophilic segment, and the ratio of each value is represented by (X)/(Y).

The hydrophobic segment has the number average molecular weight of, for example, 2000 to 300000, preferably 10000 to 100000, more preferably 9000 to 60000, and even preferably 10000 to 50000. The hydrophilic segment has the number average molecular weight of, for example, 1000 to 150000, preferably 2000 to 80000, more preferably 3000 to 50000, and even preferably 5000 to 45000. When both the hydrophobic segment and the hydrophilic segment have small number average molecular weights within the above range, the size of an average circle-equivalent diameter of the pore on the surface of the obtained film can be controlled in smaller size.

The copolymer can be prepared by, for example, a method for polymerizing a monomer B at an end of a polymer A, a method for reacting an end of a polymer A and an end of a polymer B to bind these polymers, a method for polymerizing a monomer B in the middle of a chain of a polymer A, a method for reacting middle parts of a chain of a polymer A and ends of a polymer B to bind these polymers and the like. The copolymer may be prepared by conventional methods without limiting in these methods.

The copolymer may be used with or without the other polymer as long as effects of the present invention are not prevented. The other polymer includes a homopolymer or a random copolymer produced from a monomer forming the hydrophobic segment or the hydrophilic segment.

### 1.2 Organic Solvent

As the organic solvent mentioned above, an organic solvent having low dielectric constant and high boiling point is used. In the present invention, a water vapor-containing gas is provided with the coated layer in the aging step of the next step. When the organic solvent has lower dielectric constant, self-assembly of the copolymer can be controlled in nano-size and the structure of self-assembly can become a porous structure or a fibrous structure. In addition, when the organic solvent has higher boiling point, the copolymer can be self-assembled since the necessary time (the aging time) can be secured by the end of the evaporation of the organic solvent. When an organic solvent having higher boiling point is used, it is hard to cool the coating layer, and condensation of water vapor on the coating layer can be prevented even if a water vapor-containing gas is provided. As a result, the disturbance of self-assembly of the copolymer by condensed water droplets can be prevented. The only one organic solvent may be used, or the mixture of the two or more organic solvents may be used.

The organic solvent has dielectric constant of preferably 25 or less, and more preferably 20 or less. The lower limit of dielectric constant is not needed to be specified, but may be, for example, 1 or more, and particularly 2 or more.

The organic solvent has boiling point of preferably 100° C. or more, and more preferably 120° C. or more. The upper limit of boiling point is not needed to be specified, but may be, for example, about 180° C. or less, and particularly about 160° C. or less.

In the present invention, the only one organic solvent may be used, or the mixture of the two or more organic solvents may be used. In the case where the mixture of the two or more organic solvents is used, not only do at least one organic solvent (a major solvent) satisfies both conditions of dielectric constant and boiling point as mentioned above, but also the remaining organic solvent (a minor solvent) may satisfy both conditions of dielectric constant and boiling point or either condition of dielectric constant or boiling point as mentioned above. When the minor solvent satisfies either condition of dielectric constant or boiling point, the ratio of the major solvent is, for example, preferably 30% by volume or more, more preferably 50% by volume or more, and even preferably 80% by volume or more, relative to the total 100% by volume of the major solvent and the minor solvent.

The organic solvent may be a hydrophobic solvent or a hydrophilic solvent. The classification into the hydrophobic solvent or the hydrophilic solvent is determined by solubility between the organic solvent and water. The classification of the specific solvent into the hydrophobic solvent or the hydrophilic solvent can be determined by solubility of water in the specific solvent. For example, the hydrophobic solvent can be defined as a solvent which is capable of dissolving 1% by mass or less of water at 25° C., and the hydrophilic solvent can be defined as a solvent which is capable of dissolving more than 1% by mass of water at 25° C. When the hydrophobic solvent is used, a porous structure like honeycomb is easily formed on the surface of the coating layer. When the hydrophilic solvent is used, a fibrous structure is easily formed on the surface of the coating layer.

In the present invention, the hydrophobic solvent or hydrophilic solvent may be used without combining each other, or the mixture of the two or more hydrophobic solvent and hydrophilic solvent may be used together. When the mixture of the two or more hydrophobic solvent and hydrophilic solvent may be used together, the hydrophobic solvent or the hydrophilic solvent may be a minor solvent which does not satisfy the above-mentioned range of either boiling point or dielectric constant, (especially boiling point). A solvent mixture containing the hydrophobic solvent and the hydrophilic solvent is often used as described later when water is added to the solvent. Even if water is not added, the solvent mixture may also be used for probable modification of the surface structure. The ratio of the hydrophobic solvent to the hydrophilic solvent (hydrophobic solvent/hydrophilic solvent) may be, for example, 1/99 to 99/1, 10/90 to 90/10, or 30/70 to 70/30.

The organic solvent used in the present invention is exemplified as follows. In the present invention, if the major solvent to be used is an organic solvent which satisfies the given ranges of the above-mentioned dielectric constant and boiling point, the solvent whose ranges of the dielectric constant and/or the boiling point is outside the above-mentioned range can be used as the minor solvent. Also, organic solvents including an organic solvent capable of using as the minor solvent are exemplified as follows. An example of the organic solvent is one or more organic solvents selected from the group consisting of: for example, an aromatic hydrocarbon such as hexane (hydrophobic, boiling point 69° C., dielectric constant 1.9), benzene (hydrophobic, boiling point 80° C., dielectric constant 2.3), toluene (hydrophobic, boiling point 111° C., dielectric constant 2.2), ortho-xylene (hydrophobic, boiling point 144° C., dielectric constant 2.3), meta-xylene (hydrophobic, boiling point 139° C., dielectric constant 2.4), para-xylene (hydrophobic, boiling point 138° C., dielectric constant 2.3), a mixture of two or more xylenes containing each xylene; a halogenated hydrocarbon such as methylene dichloride (hydrophobic, boiling point 40° C., dielectric constant 9.1), chloroform (hydrophobic, boiling point 61° C., dielectric constant 4.9), carbon tetrachloride (hydrophobic, boiling point 77° C., dielectric constant 2.2); a carboxylic acid such as formic acid (hydrophilic, boiling point 101° C., dielectric constant 58.5), acetic acid (hydrophilic, boiling point 118° C., dielectric constant 6.2), ethyl acetate (hydrophilic, boiling point 77° C., dielectric constant 6.0), butyl acetate (hydrophobic, boiling point 126° C., dielectric constant 5.0), methyl acetate (hydrophilic, boiling point 58° C., dielectric constant 6.7); a sulfur-containing hydrocarbon such as carbon disulfide (hydrophobic, boiling point 46° C., dielectric constant 2.6), dimethyl sulfoxide (hydrophilic, boiling point 189° C., dielectric constant 48.9); a cyclic or linear hydrocarbon such as cyclohexane (hydrophobic, boiling point 81° C., dielectric constant 2.1), hexane (hydrophobic, boiling point 69° C., dielectric constant 1.9); a nitrile such as acetonitrile (hydrophilic, boiling point 82° C., dielectric constant 37.5); an amide such as dimethyl acetamide (hydrophilic, boiling point 165° C., dielectric constant 37.8), N,N-dimethyl formamide (hydrophilic, boiling point 153° C., dielectric constant 38); an alcohol such as 1-butanol (hydrophilic, boiling point 118° C., dielectric constant 17.1), 2-propanol (hydrophilic, boiling point 82° C., dielectric constant 18.3), 1-propanol (hydrophilic, boiling point 97° C., dielectric constant 22.2), ethanol (hydrophilic, boiling point 78° C., dielectric constant 23.8), methanol (hydrophilic, boiling point 65° C., dielectric constant 33.1); a ketone such as acetone (hydrophilic, boiling point 56° C., dielectric constant 21), methyl isobutyl ketone (hydrophobic, boiling point 116° C., dielectric constant 13), methylethylketone (hydrophilic, boiling point 80° C., dielectric constant 18.5), N-methylpyrrolidone (hydrophilic, boiling point 202° C., dielectric constant 32), cyclohexanone (hydrophobic, boiling point 155° C., dielectric constant 18.3); and an ether such as tetrahydrofuran (hydrophilic, boiling point 66° C., dielectric constant 7.6), diethylether (hydrophilic, boiling point 35° C., dielectric constant 4.2), 1,4-dioxane (hydrophilic, boiling point 101° C., dielectric constant 2.2).

The organic solvent is preferably a non-halogen solvent from the view of affects to human and the like. In the non-halogen solvent, the hydrophobic solvent (the major solvent) contains preferably a ketone solvent and an ether solvent. The hydrophobic solvent is more preferably methyl isobutyl ketone or cyclohexanone.

In the non-halogenated solvent, the hydrophilic solvent (the major solvent) contains preferably a ketone solvent or an ether solvent. The hydrophilic solvent (the major solvent) is more preferably 1,4-dioxane.

The hydrophobic solvent or the hydrophilic solvent has preferably one or more groups selected from the group consisting of an ether group, a ketone group, an amino group, an amide group, an ester group and a hydroxyl group. The hydrophobic solvent or the hydrophilic solvent has particularly preferably an ether group or a ketone group.

The concentration of the copolymer in the organic solvent (gram of copolymer/liter of organic solvent) is preferably 1 to 300 g/L, more preferably 5 to 250 g/L, even preferably 10 to 200 g/L, even more preferably 15 to 170 g/L, and particularly preferably 20 to 150 g/L.

In the present invention, an additive agent may be added to the mixture of the copolymer and the organic solvent as necessary. As the additive agent, either an additive agent having an affinity for the hydrophobic segment or an additive agent having an affinity for the hydrophilic segment can be used.

The “additive agent having an affinity for the hydrophobic segment” is an additive agent having higher solubility in the hydrophobic monomer than that in the hydrophilic monomer. When the additive agent does not dissolve in the hydrophobic monomer and the hydrophilic monomer, an additive agent having higher dispersibility in the hydrophobic monomer than that in the hydrophilic monomer is also used as the “additive agent having an affinity for the hydrophobic segment”.

On the other hand, the “additive agent having an affinity for the hydrophilic segment” is an additive agent having higher solubility in the hydrophilic monomer than that in the hydrophobic monomer. When the additive agent does not dissolve in the hydrophobic monomer and the hydrophilic monomer, the “additive agent having an affinity for the hydrophilic segment” is an additive agent having higher dispersibility in the hydrophilic monomer than that in the hydrophobic monomer.

The additive agent may be classified in, for example, an agent for controlling a pore or an agent for giving functionality. When the agent for controlling a pore is added to the mixture, the inside structure of the coating layer can be modified. As the agent for controlling a pore, the additive agent having an affinity for the hydrophilic segment can be used.

The additive agent having an affinity for the hydrophilic segment includes water, an alcohol, an ether, an ionic liquid, a hydrophilic homopolymer and the like. For example, when water is used, the copolymer is self-assembled on the surface of the coating layer during the aging step as described later and water is assembled in the depths of the coating layer. After the coating layer is dried, an asymmetric membrane can be produced by the formation of a nano-structure by self-assembly of the copolymer on the surface and the formation of large pores in the depths of the coating layer, which are shaped by a mold made of water.

In addition, the additive agent having an affinity for the hydrophobic segment (the agent for giving functionality) includes a polymer and the like. The polymer includes a non-volatile oil, for example, a silicone oil such as dimethyl silicone oil, methyl phenyl silicone oil, methyl hydrogen silicone oil. The agent for giving functionality may contain, for example, a metal oxide such as SiO₂, Al₂O₃, and TiO₂, nano-particles made of Au, Ag, CdSe and the like.

The concentration of the additive agent (gram of additive agent/liter of organic solvent) is preferably 1 to 100 g/L, more preferably 2 to 80 g/L, even preferably 5 to 60 g/L, even more preferably 10 to 40 g/L, and particularly preferably 15 to 30 g/L.

When the additive agent is used, at least the hydrophilic solvent is used as the organic solvent. Specifically, the hydrophilic solvent or the solvent mixture of the hydrophobic solvent and the hydrophilic solvent is used with the additive agent. On the other hand, as above mentioned, the hydrophobic solvent is used to form a nano-structure like honeycomb on the surface. Therefore, when the nano-structure like honeycomb on the surface is formed and the inside structure of the membrane is modified to form the asymmetric membrane, the hydrophobic solvent is added to the hydrophilic solvent and the additive agent.

When the asymmetric membrane having the nano-structure like honeycomb on the surface is formed, the amount of the additive agent can be set from the same range as the concentration of the additive agent in the organic solvent as above mentioned. The amount of the hydrophilic solvent is, for example, 10 to 500 parts by mass, preferably 30 to 300 parts by mass, more preferably 50 to 150 parts by mass, relative to 100 parts by mass of the hydrophobic solvent.

On the other hand, even if the additive agent is not used, the asymmetric membrane which has the nano-structure formed on the surface and the solid structure in the inside of the membrane is generally obtained by the use of hydrophobic solvent and the hydrophilic solvent.

### 1.3 Operation

In coating step, the substrate is coated with a solution containing the copolymer, the organic solvent, and as necessary, the additive agent which may be added. By this operation, the coating layer is formed.

The substrate is not needed to be specified, but includes those formed from a silicon such as silicon wafer and glass: a non-woven fabric made of such as rayon, cotton, polyester, and nylon; a heat resistant resin such as polyethylene, polypropylene, polyetherketone, and polyfluoroethylene; an olefin resin such as polyethylene terephthalate and polybutylene terephthalate; a cellulose acetate resin such as triacetylcellulose; a thermoplastic resin such as an acrylate resin including poly methyl methacrylate; a metal such as copper, aluminium, and nickel and the like. Preferable substrate is those made of polyethylene terephthalate or triacetylcellulose.

As coating methods, a conventionally known method can be used. The coating method includes a slide method, an extrusion method, a bar method (for example, a blade coating method), a die coating method, a gravure method, a dropping method and the like. Preferable coating method is the dropping method, the die coating method or the gravure method. These preferable methods are convenient. The method of the present invention is able to applicable to a roll to roll process as above mentioned. When the preferable coating method is combined with the roll to roll process, productivity of the film is not lowered.

### 2. Step (2): Aging Step (2)

The coating layer formed as above mentioned is controlled in an aging step. In the aging step, it is required that a water vapor-containing gas having relative humidity of 50% or more is provided with the coating layer or the membrane. When a gas having high humidity is provided with the surface of the membrane, the segment of the copolymer on the surface of the membrane is affected by moisture, so that the segment is unreliably oriented according to strength of hydrophilicity. As a result, the copolymer is self-assembled on the surface of the membrane to form the fine structure in nano-size.

The gas as carrier media of water vapor is not particularly limited as long as the gas does not react with water vapor and the coating layer. The gas may be an inert gas such as nitrogen, oxygen or an air. Preferable carrier media (gas) is air.

A method for controlling humidity is not limited particularly. A carrier media may be humidified with using a conventional and suitable device for generating steam.

Relative humidity is preferably 60% or more, more preferably 65% or more, even preferably 70% or more, particularly preferably 75% or more, and most preferably 80% or more. The upper limit of relative humidity is not limited particularly, but, for example, is humidity to the degree of causing no condensation of water vapor on the surface of the coating layer. The upper limit of relative humidity is preferably less than 100%. When relative humidity is 100%, in order to avoid the condensation of water vapor, it is needed to do tedious operation, namely, it is needed to lower temperature of the surface of the coating layer than an atmospheric temperature.

The temperature of the surface of the membrane in the aging step is preferably the temperature of dew point or more. The copolymer can be self-assembled to a high degree, since condensation of water vapor on the surface of the membrane can be prevented at higher temperature than dew point. The temperature of the surface of the membrane can be higher than dew point by, for example, 1° C. or more, preferably 2° C. or more, and more preferably 3° C. or more. Specific temperature of the surface of the membrane can be suitably set according to dew point. The temperature of the surface of the membrane is, for example, 15° C. or more, preferably 16° C. or more, and more preferably 17° C. or more. The upper limit of the temperature of the surface of the membrane can be appropriately set according to boiling point of the organic solvent or the organic solvents, and it is necessary to avoid a high temperature such that the membrane is dried before self-assembly of the copolymer. The temperature of the surface of the membrane is, for example, 50° C. or less, preferably 40° C. or less, more preferably 30° C. or less, and even preferably 25° C. or less. The temperature of the surface of the membrane is preferably identical with an atmospheric temperature (an ambient temperature).

The time for aging the membrane can be appropriately set according to moisture and/or the temperature of the membrane. The time for aging the membrane is, for example, from 10 minutes to 10 hours, preferably from 20 minutes to 5 hours, and more preferably from 30 minutes to 3 hours.

### 3. Step (3): Drying Step (3)

In drying step, the nano-structure on the surface formed in the aging step is fixed after evaporation of the organic solvent in the coating layer. The atmosphere of the drying step is not limited particularly, but may be an atmosphere containing an inert gas or an air, or the same atmosphere as the aging step. When the same atmosphere as the aging step is used, the aging step can be considered to contain the drying step since it is difficult to distinguish between the aging step and the drying step.

The temperature of the drying step is not limited particularly, but may be, for example, room temperature. When the membrane is dried under unheated conditions, the nano-structure on the surface can be fixed with high accordance with the structure at the time on completion of the aging step.

### 4. Film Having Nano-Structure

The film obtained by above process has a structure in nano-size on the surface of one side of the film. Specifically, the structure is a porous structure which is formed from a continuous honeycomb structure, or a fibrous structure which is considered to be a fibrous organization.

Each of the honeycomb or the diameter of fibers can be controlled in a nano-size. In the case where the structure is the porous structure like the honeycomb, the average diameter of each honeycomb (average circle-equivalent diameter) is, for example, 1 to 200 nm, preferably 5 to 100 nm, more preferably 10 to 70 nm, and particularly preferably 15 to 50 nm. In the case of the fibrous structure, the average diameter of each of the fibers is, for example, 1 to 200 nm, preferably 3 to 100 nm, and more preferably 5 to 70 nm. The average length of each of the fibers is not limited particularly, but is, for example, 500 nm or more and preferably 800 nm or more.

The thickness of a layer which is consisted of the nano-structure in the surface of the film is, for example, 1 to 3000 nm, preferably about 3 to 1000 nm, more preferably about 5 to 500 nm, and even preferably about 10 to 200 nm.

The thickness of the whole film may be identical with the thickness of a layer which is consisted of the nano-structure in the surface of the film. In this case, the nano-structure is formed over the whole film. On the other hand, the thickness of the whole film may be thicker than that of the layer which is consisted of the nano-structure in the surface of the film. In this case, the asymmetric membrane or the asymmetric film having nano structure on the surface thereof and macro structure inside the film is formed. The thickness of the whole film can be set within the range of, for example, 5 to 20000 nm, preferably about 10 to 5000 nm, more preferably about 20 to 3000 nm, and even preferably about 30 to 2000 nm.

The inside structure of the film can be set appropriately. The inside structure may be a solid structure or may be formed by macro pores. The film may have an uniform structure containing macro pores or an inclined structure such that macro pores become large gradually, from one side of the surface having a nano-size structure to one side of the opposite surface. Whether the size of each of macro pores is uniform or inclined, the size of each of macro pores is almost the same as long as the macro pores belong to the same horizontal sectional layer. The size of each of macro pores in the layer where the macro pores become largest is, for example, about 0.5 to 3 μm and preferably about 0.7 to 2 μm.

The membrane (film) obtained by above process may be used as a individual film by separating from the substrate as necessary, or as a laminate film by piled up with other film without separating from the substrate or with separation from the substrate.

### 5. Use Application of Film

The film can be used for a various application according to shapes of the nano-structure on the surface of the film. The film obtained in the present invention can be preferably used for, for example, separation membrane, anti-reflective film, cell culture scaffold, anti-adhesive film, fingerprint resistant film. In addition, a film having on the surface a porous structure formed from a continuous honeycomb can be appropriately used for, for example, solar battery, battery electrolyte, sensor, photoresist, ointment for wetting wound, plate for blood test and the like. A film having a fibrous structure on the surface can be appropriately used for, for example, battery electrode, adhesive agent and the like.

When the film is the asymmetric membrane (especially, an asymmetric membrane having an inside structure of macro pores), the film is advantageously used as a filter membrane for water and the like, since the film has the properties of a semipermeable film and the speed of water passage becomes large. Specifically, the porous membrane on the surface can remove the fine particles and the like, the macro pores can filter the solution from the porous membrane to form flow channel of the filtrate smoothly and can maintain the strength of the membrane.

### EXAMPLES

The present invention is hereinafter described more specifically by reference to Examples; however, the present invention is not limited to these Examples, and can be put into practice after appropriate modifications or variations within a range meeting the gist of the present invention, all of which are included in the technical scope of the present invention. Hereinafter, “part” and “%” means “mass part” and “% by mass”, respectively, unless otherwise noted. Molecular weight means number average molecular weight calculated by GPC (polystyrene conversion).

### Example 1

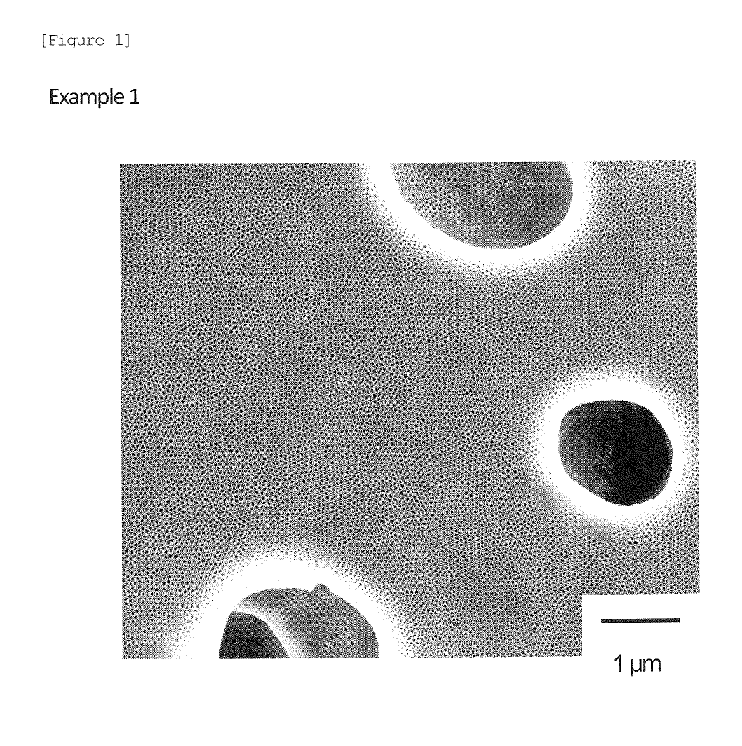

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and cyclohexanone were mixed to prepare a polymer solution having the concentration of 70 g/L. Dropped on a silicon wafer was 30 μl of the polymer solution. The polymer solution was kept under conditions at 20° C. of the temperature of the surface of the membrane and 85% of relative humidity, to evaporate cyclohexanone for three hours under the same temperature and humidity conditions. The humidity was returned into humidity of open air or room for two hours, to obtain the film having a nano-structure on the surface. The surface of the obtained film was observed by SEM. The result is shown in FIG. 1.

As can be seen from the result of FIG. 1, the surface of the film had a porous structure formed from a continuous honeycomb structure and average circle-equivalent diameter of each of the pores was about 32 nm.

### Example 2

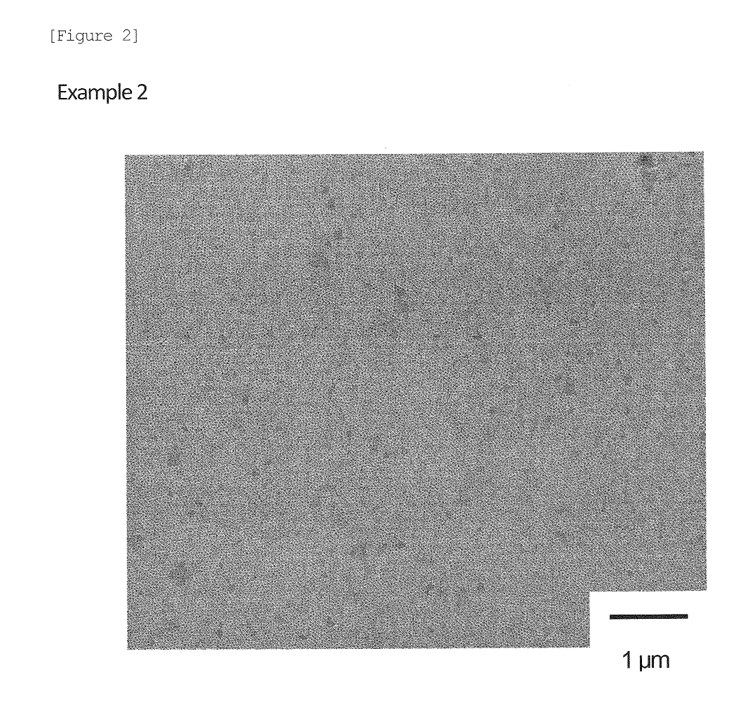

A block copolymer consisting of polystyrene having the molecular weight of 20000 and polyethylene oxide having the molecular weight of 7000 (PS-b-PEO, 20k-b-7k, volume ratio: 74/26, molecular weight distribution: 1.06), and cyclohexanone were mixed to prepare a polymer solution having the concentration of 140 g/L. Dropped on a silicon wafer was 30 μl of the polymer solution under conditions at 20° C. of the temperature of the surface of the membrane and 85% of relative humidity, to evaporate water and cyclohexanone in air drying for three hours under the same temperature and humidity conditions. The humidity was returned into humidity of open air or room for two hours, to obtain a film having a nano-structure on the surface. The surface of the obtained film was observed by SEM. The result is shown in FIG. 2.

AS can be seen from the result of Figure. 2, the surface of the film had a porous structure like honeycomb and average circle-equivalent diameter of each of the pores was about 14 nm.

### Example 3

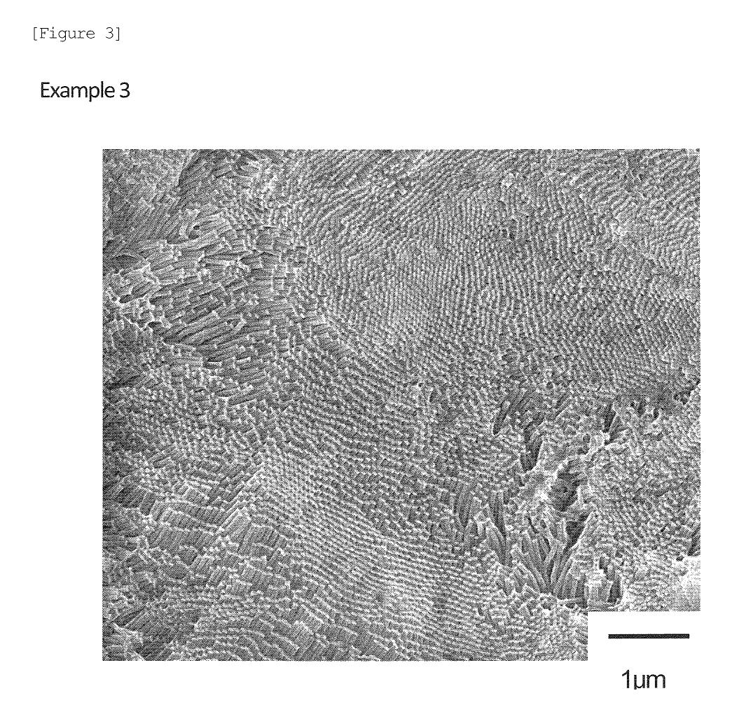

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and 1,4-dioxane were mixed to prepare a polymer solution having the concentration of 100 g/L. Dropped on a silicon wafer was 30 μl of the polymer solution under conditions at 20° C. of the temperature of the surface of the membrane and 80% of relative humidity, to evaporate water and 1,4-dioxane in air drying for three hours under the same temperature and humidity conditions. The humidity was returned into humidity of open air or room for two hours, to obtain a film having a nano-structure on the surface. The surface of the obtained film was observed by SEM. The result is shown in FIG. 3.

As can be seen from the result of FIG. 3, the surface of the film had a fibrous structure in nano-size and the size of each fiber was about 50×1000 nm.

### Example 4

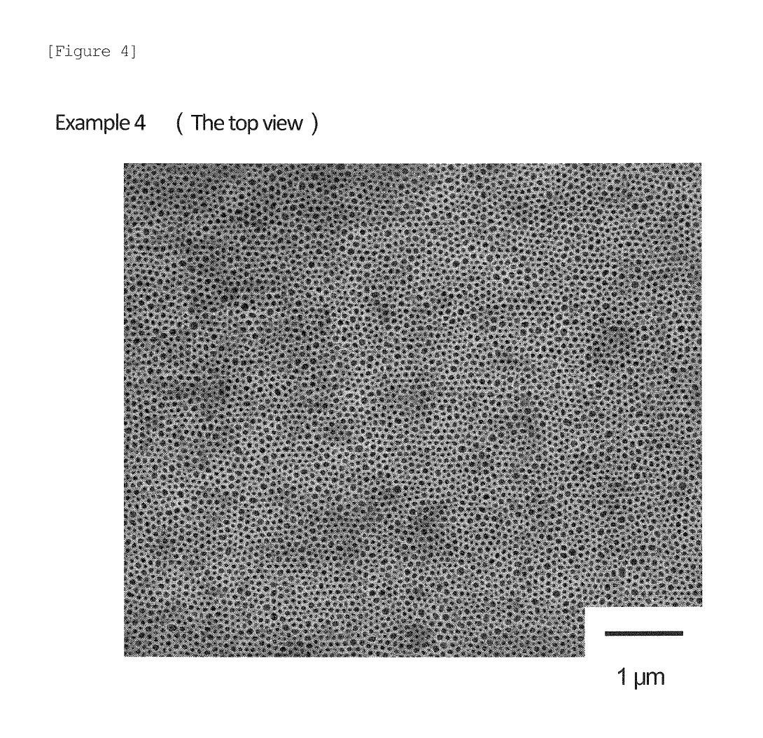

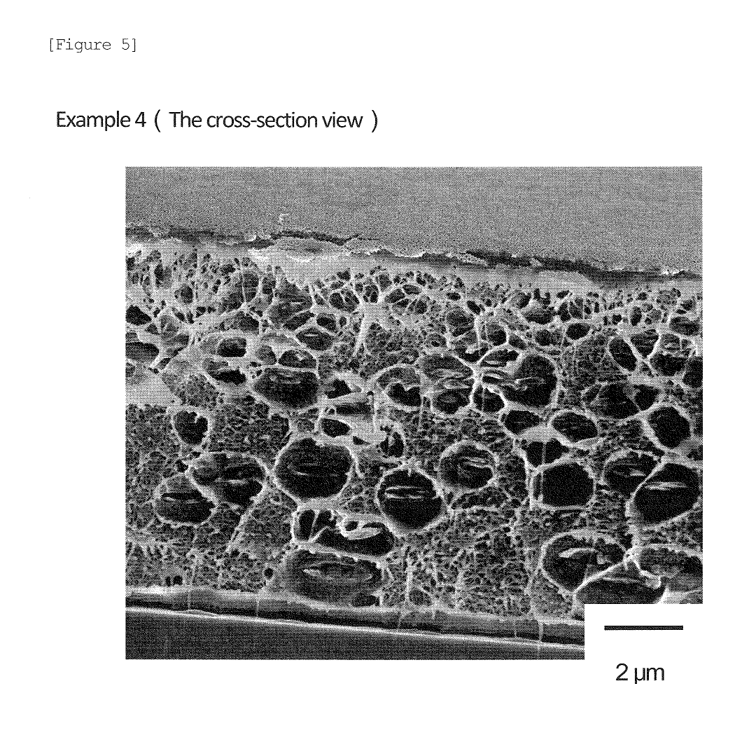

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), cyclohexanone, and tetrahydrofuran were mixed so as to be the concentration of 70 g/L. Water was added thereto so as to be 20 g/L (gram of water/liter of total organic solvents), to prepare a polymer solution. Dropped on a silicon wafer was 30 μl of the polymer solution under conditions at 20° C. of the temperature of the surface of the membrane and 85% of relative humidity, to evaporate water and cyclohexanone and tetrahydrofuran in air drying for three hours under the same temperature and humidity conditions. The humidity was returned into humidity of open air or room for two hours, to obtain a film having a nano-structure on the surface. The surface of the obtained film was observed by SEM. The result is shown in FIG. 4. In addition, the cross-section of the film was observed by SEM. The result is shown in FIG. 5.

As can be seen from the results of FIGS. 4 and 5, an asymmetric membrane was formed, in which a porous structure like honeycomb was formed on the surface of the film, average circle-equivalent diameter of each of the pores was about 48 nm, and micro pores were in the inside of the film.

### Example 5

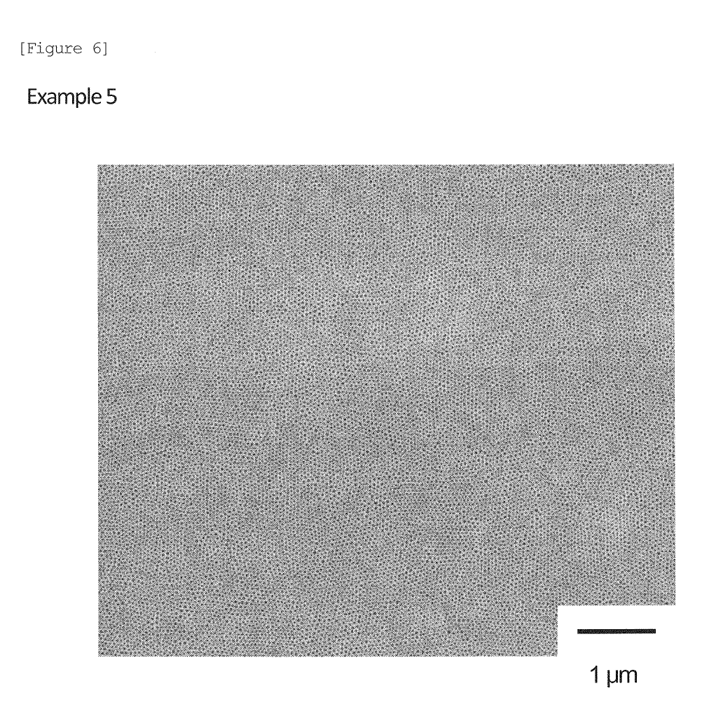

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and cyclohexanone were mixed to prepare a polymer solution having the concentration of 30 g/L. The polymer solution was dropped on a slide glass (178 mm×127 mm) with a blade coater having a gap of 1 Mil (25.4 μm) under conditions at 20° C. of the temperature of the surface of the membrane and 85% of relative humidity, to evaporate water and cyclohexanone in air drying for two hours under the same temperature and humidity conditions. The humidity was returned into humidity of open air or room for three hours, to obtain a film having a nano-structure on the surface. The surface of the obtained film was observed by SEM. The result is shown in FIG. 6.

As can be seen from the result of FIG. 6, the surface of the film had a porous structure like honeycomb and average circle-equivalent diameter of each of the pores was about 28 nm.

### Comparative Example 1

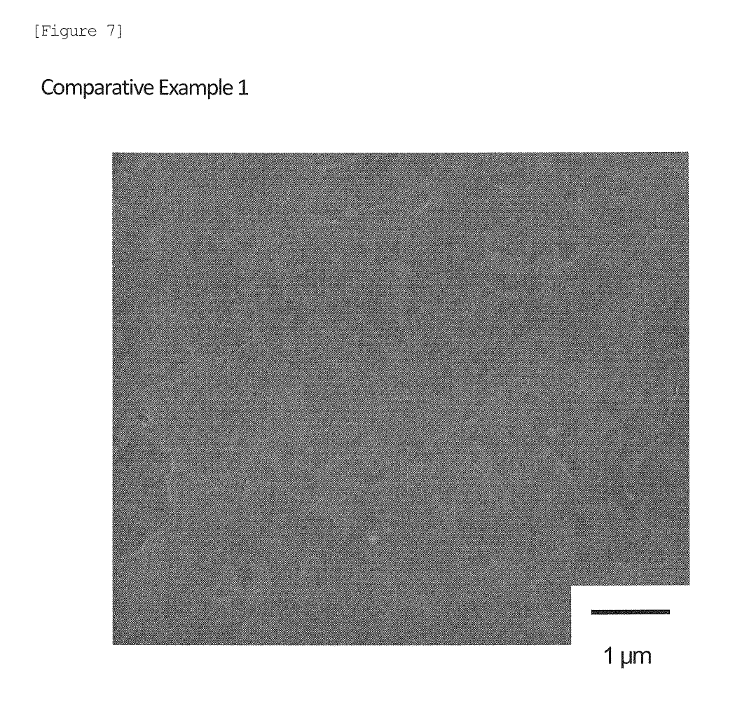

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and benzene were mixed to prepare a polymer solution having the concentration of 70 g/L. Dropped on a silicon wafer was 30 μl of the polymer solution under conditions at 20° C. of the temperature of the surface of the membrane and 85% of relative humidity, to evaporate water and benzene in air drying for two hours under the same temperature and humidity conditions. The humidity was returned into humidity of open air or room for three hours to obtain a film. The surface of the obtained film was observed by SEM. The result is shown in FIG. 7.

As can be seen from the result of FIG. 7, the surface of the film did not have a nano-structure.

### Comparative Example 2

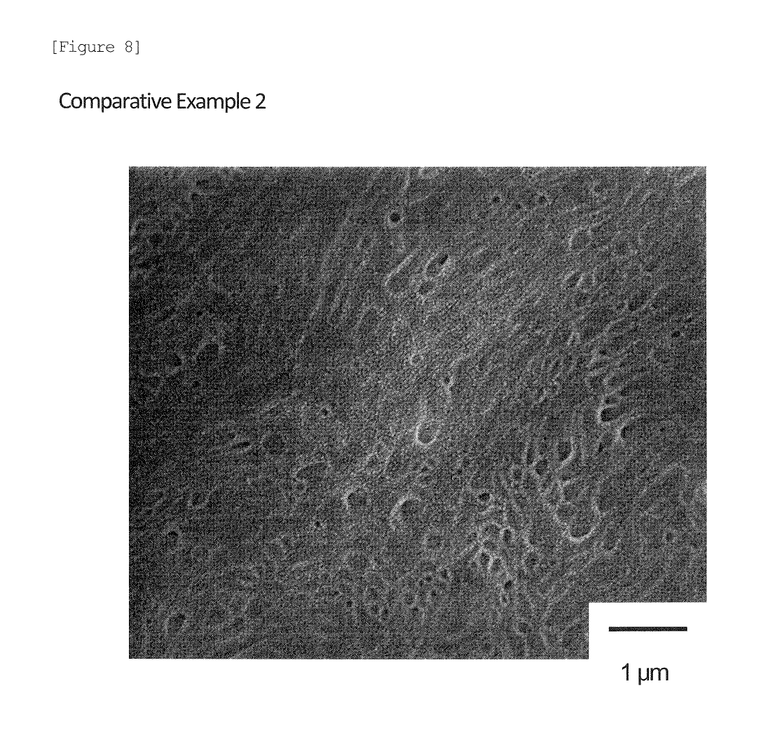

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and tetrahydrofuran were mixed to prepare a polymer solution having the concentration of 70 g/L. Dropped on a silicon wafer was 30 μl of the polymer solution under conditions at 20° C. of the temperature of the surface of the membrane and 85% of relative humidity, to evaporate water and tetrahydrofuran in air drying for three hours under the same temperature and humidity conditions. The humidity was returned into humidity of open air or room for two hours to obtain a film. The surface of the obtained film was observed by SEM. The result is shown in FIG. 8.

As can be seen from the result of FIG. 8, the surface of the film did not have a nano-structure.

### Comparative Example 3

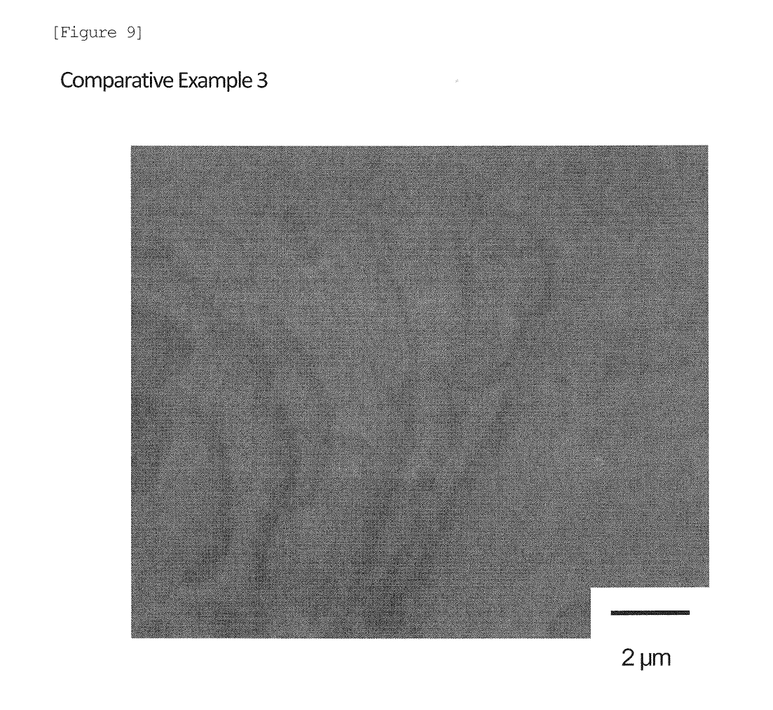

A block copolymer consisting of polystyrene having the molecular weight of 40000 and polyethylene oxide having the molecular weight of 35000 (PS-b-PEO, 40k-b-35k, volume ratio: 56/44, molecular weight distribution: 1.08), and cyclohexanone were mixed to prepare a polymer solution having the concentration of 70 g/L. Dropped on a silicon wafer was 30 μl of the polymer solution under conditions at 20° C. of the temperature of the surface of the membrane and 20% of relative humidity, to evaporate water and cyclohexanone in air drying for two hours under the same temperature and humidity conditions. The humidity was returned into humidity of open air or room for three hours to obtain a film. The surface of the obtained film was observed by SEM. The result is shown in FIG. 9.

As can be seen from the result of FIG. 9, the surface of the film did not have a nano-structure.

Conditions used and shapes of films obtained in the Examples 1 to 5 and Comparative Examples 1 to 3 are shown in Table 1.

TABLE 1

| | | | | Additive agent | | |
|---|---|---|---|---|---|---|
| | | | | concentration | | |
| | | | Concentration | [(Additive | | |
| | Copolymer (Molecular | Organic solvent | (Copolymer/Organic | agent/Organic | Relative | |
| Number | weight k) | (Boiling point ° C.) | solvent) = (g/L) | solvent) = (g/L)] | humidity | Shape of film |
| Example 1 | PS-b-PEO(40-b-35) | Cyclohexanone(155) | 70 | — | 85% | Porous structure having |
| | | | | | | nano pores on the surface |
| Example 2 | PS-b-PEO(20-b-7) | Cyclohexanone(155) | 140 | — | 85% | Porous structure having |
| | | | | | | nano pores on the surface |
| Example 3 | PS-b-PEO(40-b-35) | 1,4-dioxane(101) | 100 | — | 80% | Fibrous structure having |
| | | | | | | nano fibers on the surface |
| Example 4 | PS-b-PEO(40-b-35) | Cyclohexanone(155)/ | 70 | Water 20 g/L | 85% | Asymmetric membrane |
| | | THF(66) = 1/1 | | | | (containing nano pores on |
| | | (vol/vol) | | | | the surface and macro |
| | | | | | | pores inside) |
| Example 5 | PS-b-PEO(40-b-35) | Cyclohexanone(155) | 30 | — | 85% | Porous structure having |
| | | | | | | nano pores on the surface |
| Comparative | PS-b-PEO(40-b-35) | Benzene(80) | 70 | — | 85% | No nano structure on the |
| Example 1 | | | | | | surface |
| Comparative | PS-b-PEO(40-b-35) | THF(66) | 70 | — | 85% | No nano structure on the |
| Example 2 | | | | | | surface |
| Comparative | PS-b-PEO(40-b-35) | Cyclohexanone(155) | 70 | — | 20% | No nano structure on the |
| Example 3 | | | | | | surface |

The film of the present invention having a nano-structure on the surface of the film can be preferably used for, for example, solar battery, battery electrolyte, battery electrode, sensor, photoresist, separation membrane, antireflective film, adhesive agent, cell culture scaffold, anti-adhesive film, ointment for wetting wound, fingerprint resistant film, plate for blood test and the like.

What is claimed is:

1. A method for producing a film having a nano-structure on the surface of the film, comprising the steps of
(1) coating a substrate with a solution containing a copolymer including two or more homopolymer segments and an organic solvent having boiling point of 82° C. or more and dielectric constant of 30 or less to form a membrane,
(2) providing the membrane with a water vapor-containing gas having relative humidity of 50% or more to age the membrane, and
(3) drying the membrane to obtain the film.

2. The method according to claim 1, wherein the copolymer is an amphiphilic polymer containing a hydrophilic homopolymer segment and a hydrophobic homopolymer segment.

3. The method according to claim 1, wherein the homopolymer segments are an organic polymer segment containing a carbon atom in the main chain or an inorganic polymer segment containing no carbon atom in the main chain.

4. The method according to claim 2, wherein the hydrophobic homopolymer segment is an inorganic polymer segment or an organic polymer segment obtained from a hydrophobic monomer having water solubility of 1% by mass or less, and the hydrophilic homopolymer segment is an organic polymer segment obtained from a hydrophilic monomer having water solubility of more than 1% by mass.

5. The method according to claim 4, wherein the hydrophobic monomer is constituted from a carbon atom, a hydrogen atom and a halogen atom as needed, and the hydrophilic monomer is constituted from a carbon atom, a hydrogen atom and a functional group other than a halogen atom.

6. The method according to claim 2, wherein the volume of the hydrophilic homopolymer segment is 10% or more relative to the total volume of the hydrophilic homopolymer segment and the hydrophobic homopolymer segment.

7. The method according to claim 1, wherein the temperature of the surface of the membrane in the step (2) is 15° C. or more.

8. The method according to claim 1, wherein the organic solvent is a non-halogen solvent.

9. The method according to claim 1, wherein the organic solvent is a hydrophobic solvent.

10. The method according to claim 1, wherein the organic solvent is a hydrophilic solvent.

11. The method according to claim 1, wherein the organic solvent is a solvent mixture containing two or more solvents.

12. The method according to claim 1, wherein the organic solvent is a solvent mixture containing a hydrophobic solvent and a hydrophilic solvent.

13. The method according to claim 12, further comprising an additive agent having an affinity for the hydrophilic homopolymer segment.
